(19) United States
(12) Patent Application Publication
(10) Pub. No.: US 2008/0093991 A1
(43) Pub. Date: Apr. 24, 2008

(54) Floating Mount Structure for Metal Halide Lamps

(75) Inventor: Junming Tu, Bath, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,037

(22) PCT Filed: Jul. 13, 2005
(86) PCT No.: PCT/IB05/52331

§ 371 Date: Jan. 12, 2007

Related U.S. Application Data
(60) Provisional application No. 60/588,278, filed on Jul. 15, 2004.

(51) Int. Cl. H01J 61/00

(52) U.S. Cl. 313/567

(57) ABSTRACT

A discharge lamp employs an arc tube (30), an outer bulb envelope (20), and a floating mount structure for mounting the arc tube within the outer bulb envelope. The floating mount structure employs a metal strap (60, 61) engaging a pinch (31, 32) of the arc tube and a frame wire (41-43) electrically connected to an electrode extending through the pinch. The metal strap is electrically isolated from the frame wire to thereby impede a production of photoelectrons by the metal strap when the lamp is in operation. The electric isolation of the metal strap from the frame wire can be established by electrically insulating (100) any connection of the metal strap to the frame wire and by establishing an air gap (AG1) between any unconnected portions of the metal strap and the frame wire.

The present invention generally relates to discharge lamps. The present invention specifically relates to a mounting structure for mounting an arc tube within an outer bulb envelope of a metal halide lamp.

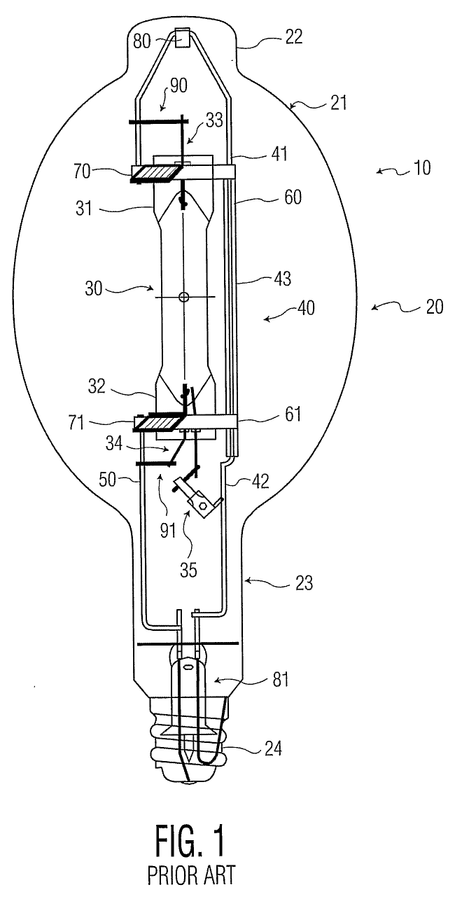

FIG. 1 illustrates a high wattage metal halide lamp 10 having a known charged mounting structure for mounting an arc tube 30 within an outer bulb envelope 20 having a dome 21 region highlighted by a dome 22 and a base region 23 highlighted by a base 24. The charged mounting structure employs a frame including a primary frame wire 40 and a secondary frame wire 50. Primary frame wire 40 has a dome wire segment 41, a base wire segment 42, and an insulator wire segment 43 between wire segments 41 and 42. The charged mounting structure further employs a dome metal strap 60, a base metal strap 61, a dome getter 70, a base getter 71, a spring strap 80, a stem 81, a dome connector 90 and a base connector 91. The assembly of the charged mounting structure within outer bulb envelope 20 involves several key connections.

First, dome metal strap 60 engages a dome pinch 31 of arc tube 30, and is electrically connected to both ends of dome wire segment 41 via a physical connection of dome metal strap 60 to both ends of dome wire segment 41.

Second, dome getter 70 is electrically connected to dome metal strap 60 via a physical connection of dome getter 70 to dome metal strap 60.

Third, an apex of dome wire segment 41 is physically connected to dome 21 of outer bulb envelope 20 by spring strap 80.

Fourth, dome connector 90 electrically connects dome wire segment 41 to a lead-through of a dome electrode 33 extending through dome pinch 31 via a physical connection of dome connector 90 to both dome wire segment 41 and the lead-through of dome electrode 33.

Fourth, base metal strap 61 engages a base pinch 32 of arc tube 30, is physically connected to insulated wire section 43, and is electrically connected to secondary frame wire 50 via a physical connection of base metal strap 61 to secondary frame wire 50.

Fifth, base getter 71 is electrically connected to base metal strap 61 via a physical connection of base getter 71 to base metal strap 61.

Sixth, base connector 91 electrically connects secondary frame wire 50 to a lead-through of a base electrode 34 extending through base pinch 32 via a physical connection of base connector 91 to both secondary frame wire 50 and the lead-through of base electrode 34.

Seventh, a starter switch 35 extending through base pinch 32 is physically connected to base wire segment 42.

Finally, stem 81 physically connects frame wires 40 and 50 to base 24.

As is well known in the art, an operation of lamp 10 will charge the metal parts of lamp 10. As such, the metal parts of lamp 10 will produce photoelectrons when lamp 10 is in operation whereby the photoelectrons will deposit on a surface of arc tube 30. This results in an extraction of sodium from arc tube 30, which negatively affects the performance of lamp 10. The lighting industry is therefore continually striving to improve upon the existing technology related to mounting arc tubes within an outer bulb envelope.

To this end, the present invention is a discharge lamp (e.g., a high wattage metal halide lamp) employing an arc tube, an outer bulb envelope, and a new and unique floating mount structure for mounting the arc tube within the outer bulb envelope. The floating mount structure employs a metal strap engaging a pinch of the arc tube and a frame wire connected to an electrode extending through the pinch. The metal strap is electrically isolated from the frame wire to thereby impede a production of photoelectrons by the metal strap when the lamp is in operation. The electric isolation of the metal strap from the frame wire is accomplished by an electric insulation of any connection of the metal strap to the frame wire and by a minimum air gap distance between unconnected portions of the metal strap and the frame wire.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

FIG. 1 illustrates a high wattage metal halide lamp employing a charged mount structure as known in the art;

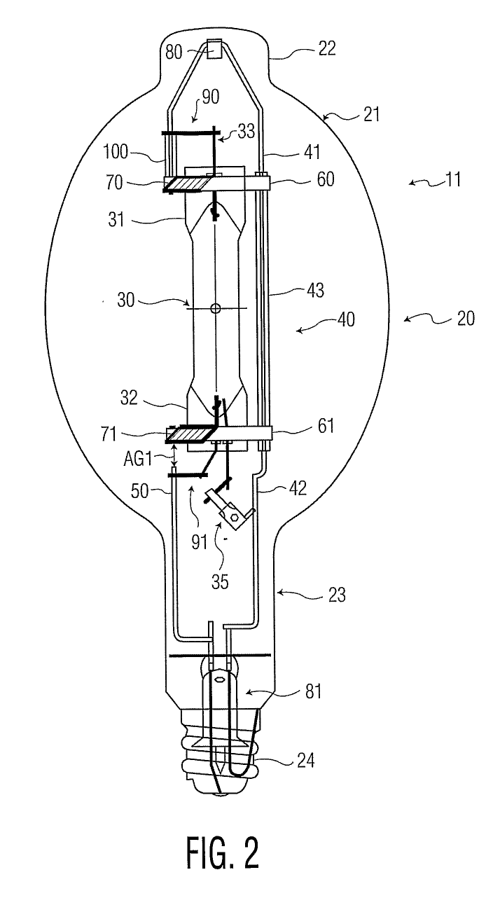

FIG. 2 illustrates a high wattage metal halide lamp employing a first embodiment of a floating mount structure in accordance with the present invention;

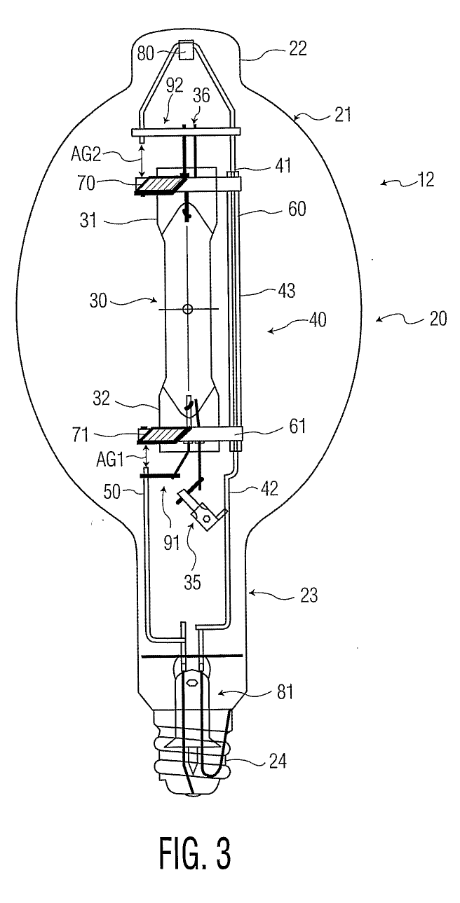

FIG. 3 illustrates a high wattage metal halide lamp employing a second embodiment of a floating mount structure in accordance with the present invention;

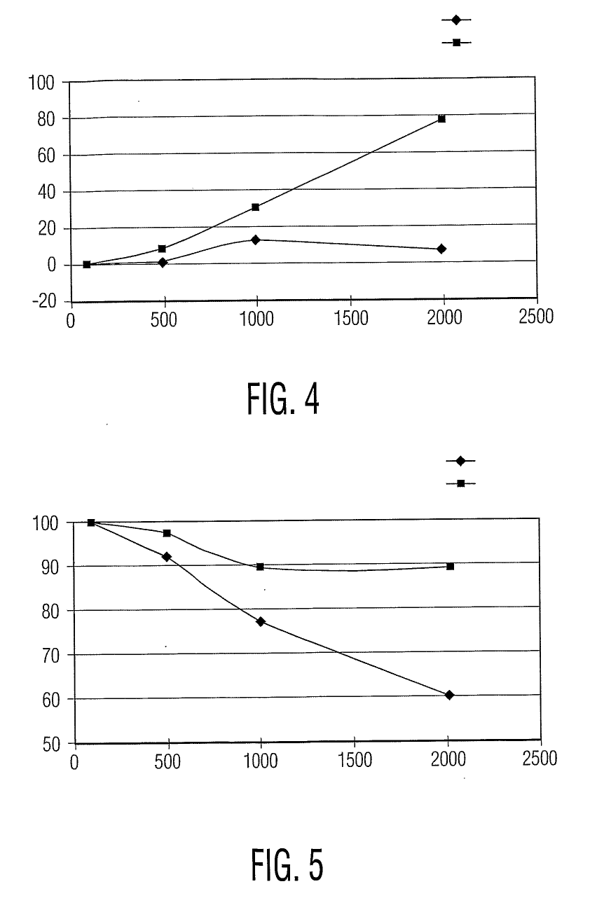

FIG. 4 illustrates an exemplary graph of a voltage rise in a vacuum over time for a 1000 watt version of the lamp illustrated in FIG. 1 and of the lamps illustrated in FIGS. 2 and 3;

FIG. 5 illustrates an exemplary graph of a lumen maintenance in a vacuum over time for a 1000 watt version of the lamp illustrated in FIG. 1 and of the lamps illustrated in FIGS. 2 and 3;

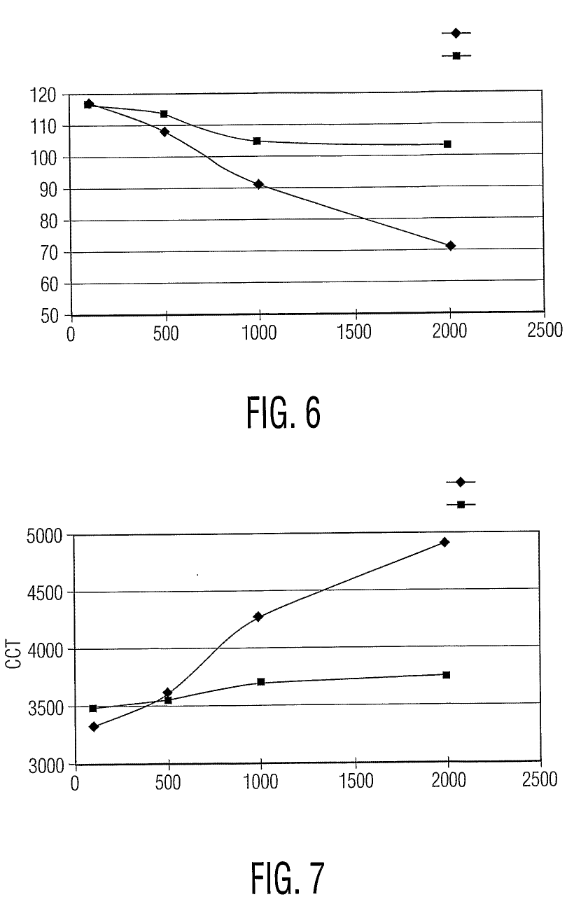

FIG. 6 illustrates an exemplary graph of a lamp efficacy in a vacuum over time for a 1000 watt version of the lamp illustrated in FIG. 1 and of the lamps illustrated in FIGS. 2 and 3;

FIG. 7 illustrates an exemplary graph of a color shift in a vacuum over time for a 1000 watt version of the lamp illustrated in FIG. 1 and of the lamps illustrated in FIGS. 2 and 3; and

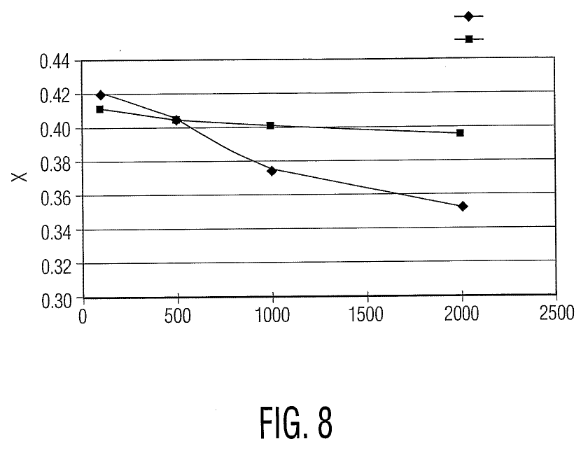

FIG. 8 illustrates an exemplary graph of an x-coordinate in a vacuum over time for a 1000 watt version of the lamp illustrated in FIG. 1 and of the lamps illustrated in FIGS. 2 and 3.

The drawings illustrated in FIGS. 1-3 are not intended to be drawn to scale, but to facilitate an understanding of various principles of the present invention. Those having ordinary skill in the art will appreciate that, in practice, the actual shapes, dimensions and material construction of each discharge lamp in accordance with the present invention are dependent upon an intended commercial application of the discharge lamp. Thus, the inventor of the present invention does not impose any restrictions as to the shapes, dimensions and material construction of each discharge shape, and does not assert any “best” shape or any “best” dimension or any “best” material construction of each discharge lamp in accordance with the present invention.

One inventive principle of the present invention is to electrically isolate each metal strap and each getter from each frame wire to thereby impede a production of photoelectrons by the metal strap(s) and the getter(s) when the lamp is in operation. This is accomplished by an electric insulation of any connection of a metal strap to one or more of the frame wires and by establishing a minimum air gap between unconnected portions of the metal strap(s) and the frame wire(s).

The following descriptions of FIGS. 2 and 3 provide exemplary embodiments of the present invention incorporating the aforementioned inventive principle of the present invention.

FIG. 2 illustrates a high wattage metal halide lamp 11 having a floating mount structure for mounting arc tube 30 within outer bulb envelope 20. This floating mount structure employs primary frame wire 40, secondary frame wire 50, dome metal strap 60, base metal strap 61, dome getter 70, base getter 71, spring strap 80, stem 81, dome connector 90 and base connector 91 as previously introduced in connection with FIG. 1. To electrically isolate metal strap 60 and getter 70 from frame wires 40 and 50, an insulator 100 (e.g., 3 mm length) is wrapped around a portion of dome wire section 41 adjacent the physical connection of metal strap 60 to dome wire section 41, and adjacent the physical connection of dome connector 90 to dome wire section 41. Additionally, metal strap 60 is physically connected to insulated wire section 43 and spaced from the boundary between dome wire section 41 and insulated wire section 43 (e.g., 3 mm spatial distance), and metal strap 60 is considerably spaced from frame wire 50. To electrically isolate metal strap 61 and getter 71 from frame wires 40 and 50, an air gap AG1 (e.g., 8 mm air gap) is established between frame wire 50 and metal strap 61. Additionally, metal strap 61 is physically connected to insulated wire section 43 and spaced from the boundary between base wire section 42 and insulated wire section 43 (e.g., 3 mm spatial distance).

FIG. 3 illustrates a high wattage metal halide lamp 12 having another floating mount structure for mounting arc tube 30 within outer bulb envelope 20. This floating mount structure also employs primary frame wire 40, secondary frame wire 50, dome metal strap 60, base metal strap 61, dome getter 70, base getter 71, spring strap 80, stem 81, and base connector 91 as previously introduce in connection with FIG. 1. This floating mount structure further employs a dome connector 92 in lieu of dome connector 90 (FIG. 1). To electrically isolate metal strap 60 and getter 70 from frame wires 40 and 50, an air gap AG2 (e.g., 8 mm air gap) is established between frame wire 40 and metal strap 60. Additionally, metal strap 60 is physically connected to insulated wire section 43 and spaced from the boundary between dome wire section 41 and insulated wire section 43 (e.g., 3 mm spatial distance), and metal strap 60 is considerably spaced from frame wire 50. To support the weight of arch tube 30, connector 92 is further physically connected to both legs of dome wire section 41 as well as a hairpin 36 extending into dome pinch 31. To electrically isolate metal strap 61 and getter 71 from frame wires 40 and 50, air gap AG1 is again established between frame wire 50 and metal strap 61, and metal strap 61 is physically connected to insulated wire section 43 and spaced from the boundary between base wire section 42 and insulated wire section 43 (e.g., 3 mm spatial distance).

An accelerated life test of lamps in accordance with lamps 10-12 (FIGS. 1-3) for up to 2,000 hours demonstrated that the floating mount structure provides much less voltage rise, better lumen maintenance, and better color consistency than the prior art charged mount structure. Graphs 110-114 as illustrated in FIGS. 4-8 exemplarily highlight this distinction between the floating mount structure and the prior art charged mount structure based on 1000 watt metal halide versions of lamps 10-12. A chemical analysis of arc tubes in accordance with lamps 10-12 revealed a much slower sodium diffusion for the floating mount structure as compared to the prior art charged mount structure. The following TABLE 1 exemplarily highlights this distinction between the floating mount structure and the prior art charged mount structure based on 1000 watt metal halide versions of lamps 10-12:

TABLE 1

| | Lamp ID | | | |
|---|---|---|---|---|
| | 1 | 2 | 3 | 4 |
| | Structure | | | |
| | Floating Mount Structure | | Charged Mount Structure | |
| | 1000 W | 1000 W | 1000 W | 1000 W |
| | 2000 hrs. | 2000 hrs. | 2000 hrs. | 2000 hrs. |
| Outer bulb | | | | |
| Inner Bulb μg | 140 | 49.7 | 373 | 308 |
| Na | | | | |
| Stem μg Na | 24.5 | 14.1 | 28.8 | 30.9 |
| Base μg Na | 47.5 | 22.9 | 28.3 | 72.0 |
| Al₂O₃ μg Na | 56.6 | 22.7 | 26.5 | 26.5 |
| Arc tube | | | | |
| Na mg | 7.806 | 7.996 | 3.812 | 3.492 |
| I mg | 54.8 | 54.9 | 47.5 | 42.5 |
| Th μg | 894 | 475 | 382 | 196 |
| Sc μg | 868 | 693 | 927 | 466 |

Clearly, the floating mount structure of the present invention provides advantages over the prior art charged mount structure.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A discharge lamp (11, 12), comprising:
an outer bulb envelope (20);
an arc tube (30) disposed within the outer bulb envelope (20), the arc tube (30) including a first pinch (31) and a first electrode (33) extending through the first pinch (31); and
a floating mount structure disposed within the outer bulb envelope (20), the floating mount structure including a first frame wire (40) electrically connected to the first electrode (33) and a first metal strap (60) engaging the first pinch (31),
wherein the first metal strap (60) is electrically isolated from the first frame wire (40) to impede a production of photoelectrons by the first metal strap (60) when the discharge lamp (11, 12) is in operation.

2. The discharge lamp (11) of claim 1,
wherein the first metal strap (60) is physically connected to a wire segment (41) of the first frame wire (40); and
wherein the physical connection of the first metal strap (60) to the wire segment (41) is electrically insulated to thereby facilitate the electric isolation of the first metal strap (60) from the first frame wire (40).

3. The discharge lamp (11) of claim 2, wherein the floating mount structure further includes:
an insulator (100) wrapping a portion of the wire segment (41) adjacent the physical connection of the first metal strap (60) to the wire segment (41) to thereby electrically insulate physical connection of the first metal strap (60) to the wire segment (41).

4. The discharge lamp (11) of claim 1,
wherein the first frame wire (40) includes an insulated wire segment (43);
wherein the first metal strap (60) is physically connected to the insulated wire segment (43) to thereby facilitate the electric isolation of the first metal strap (60) from the first frame wire (40).

5. The discharge lamp (12) of claim 1,
wherein the first frame wire (40) includes a wire segment (41); and
wherein an air gap (AG2) exists between the first metal strap (60) and a first end of the wire segment (41) to facilitate an electric isolation of the first metal strap (60) from the first frame wire (40).

6. The discharge lamp (12) of claim 5,
wherein the arc tube (30) further includes a hairpin (36) extending into the first pinch (31); and
wherein the first frame wire (40) is electrically connected to the hairpin (36).

7. The discharge lamp (12) of claim 6,
wherein the first frame wire (40) includes a wire segment (41) electrically connected to the first electrode (33) and the hairpin (36).

8. The discharge lamp (11, 12) of claim 1, wherein the floating mount structure further includes:
a getter (70) electrically connected to the first metal strap (60) whereby the electric isolation of the first metal strap (60) from the first frame wire (40) impedes a production of photoelectrons by the getter (70) when the lamp (11, 12) is in operation.

9. The discharge lamp (12) of claim 1,
wherein the arc tube (30) includes a second pinch (32) and a second electrode (34) extending through the second pinch (32);
wherein the floating mount structure further includes a second frame wire (50) electrically connected to the second electrode (34) and a second metal strap (61) engaging the second pinch (32); and
wherein the first metal strap (60) and the second metal strap (61) are electrically isolated from both the first frame wire (40) and the second frame wire (50) to impede a production of photoelectrons by the first metal strap (60) and the second metal strap (61) when the discharge lamp (11, 12) is in operation.

10. The discharge lamp (11) of claim 9,
wherein the first metal strap (60) is physically connected to a wire segment (41) of the first frame wire (40); and
wherein the physical connection of the first metal strap (60) to the wire segment (41) is electrically insulated to thereby facilitate the electric isolation of the first metal strap (60) from the first frame wire (40).

11. The discharge lamp (11) of claim 10, wherein the floating mount structure further includes:
an insulator (100) wrapping a portion of the wire segment (41) adjacent the physical connection of the first metal strap (60) to the wire segment (41) to thereby electrically insulate physical connection of the first metal strap (60) to the wire segment (41).

12. The discharge lamp (11) of claim 9,
wherein the first frame wire (40) includes an insulated wire segment (43); and
wherein the first metal strap (60) is physically connected to the insulated wire segment (43) to thereby facilitate the electric isolation of the first metal strap (60) from the first frame wire (40).

13. The discharge lamp (11) of claim 12,
wherein the second metal strap (61) is physically connected to the insulated wire segment (43) to thereby facilitate the electric isolation of the second metal strap (61) from the first frame wire (40).

14. The discharge lamp (12) of claim 9,
wherein the first frame wire (40) includes a wire segment (41);
wherein an air gap (AG2) exists between the first metal strap (60) and a first end of the wire segment (41) to facilitate an electric isolation of the first metal strap (60) from the first frame wire (40).

15. The discharge lamp (12) of claim 14,
wherein the arc tube (30) further includes a hairpin (36) extending into the first pinch (31); and
wherein the first frame wire (40) is electrically connected to the hairpin (36).

16. The discharge lamp (12) of claim 15,
wherein the first frame wire (40) includes a wire segment (41) electrically connected to the first electrode (33) and the hairpin (36).

17. The discharge lamp (12) of claim 9,
wherein an air gap (AG1) exists between the second metal strap (61) and a first end of the second frame wire (50) to facilitate an electric isolation of the second metal strap (1) from the second frame wire (50).

18. The discharge lamp (11, 12) of claim 9, wherein the floating mount structure further includes:
a getter (70) electrically connected to the first metal strap (60) whereby the electric isolation of the first metal strap (60) from the first frame wire (40) and the second frame wire (50) impedes a production of photoelectrons by the getter (70) when the lamp (11, 12) is in operation.

19. A discharge lamp (11, 12), comprising:
an outer bulb envelope (20);
an arc tube (30) disposed within the outer bulb envelope (20);
a floating mount structure disposed within the outer bulb envelope (20), the floating mount structure including at least one frame wire (40, 50) and at least one metal strap (60, 61) mounting the arc tube (30) to the outer bulb envelope (20),
wherein the floating mount structure includes means for electrically isolating the each metal strap of the at least one metal strap (60, 61) from each frame wire of the at least one frame wire (40, 50) to thereby impede a production of photoelectrons by each metal strap of the at least one metal strap (60, 61) when the discharge lamp (11, 12) is in operation.

20. The discharge lamp (11, 12) of claim 18, wherein the floating mount structure further includes:
a getter (70) electrically connected to a first metal strap (60) of the at least one metal straps (60, 61) whereby the electric isolation of the first metal strap (60) from each frame wire of the at least one frame wire (40, 50) impedes a production of photoelectrons by the getter (70) when the lamp (11, 12) is in operation.
